(19) United States
(12) Patent Application Publication
(10) Pub. No.: US 2003/0175652 A1
(43) Pub. Date: Sep. 18, 2003

(54) One-piece disposable dental articulator

(76) Inventor: Oral Fatih Sekendur, Chicago, IL (US)

Correspondence Address: ORAL SEKENDUR, 399 W. FULLERTON PKWY, CHICAGO, IL, 60614, US

(21) Appl. No.: 09/755,231

(22) Filed: Jan. 8, 2001

(51) Int. Cl. A61C 11/00

(52) U.S. Cl. 433/57

(57) ABSTRACT

Abstract This invention relates to a disposable one-piece dental articulator. It is formed in one piece from a single sheet of plastic whereby the upper and lower quadrants are scored perpendicular to the vertical length of the dental articulator to form the two hinged ends and a body member. The hinges allow the upper and lower members free radial motion about the axis of the scored hinges and they are able to fold flush against the body member. On either side of the two hinges are retention holes to secure the articulated dental models.

### FIELD OF INVENTION

This invention relates to a disposable one-piece dental articulator. It is formed in one piece from a single sheet of plastic whereby the upper and lower quadrants are scored perpendicular to the vertical length of the dental articulator to form the two hinged ends and a body member. The hinges allow the upper and lower members free radial motion about the axis of the scored hinges and they are able to fold flush against the body member. On either side of the two hinges are retention holes to secure the articulated dental models.

### DESCRIPTION OF PRIOR ART

The following United States Patents are most closely related to the present invention:

| | | | |
|---|---|---|---|
| 5,026,279 | June 1991 | Wilkes | 433/60. |
| 5,045,949 | September 1991 | Richardson | 433/57. |
| 5,076,786 | December 1991 | Callne | 433/60. |
| 5,141,433 | August 1992 | Peterson | 433/64. |
| 5,221,203 | June 1993 | Callne | 433/58. |
| 5,360,337 | November 1994 | Westdyk | 433/54. |
| 5,425,636 | June 1995 | Ghim | 433/64. |
| 5,622,497 | April 1997 | Cho | 433/60. |
| 5,769,634 | June 1998 | Choi | 433/64. |
| 5,957,688 | September 1999 | Van Valey | 433/60 |

| | | | |
|---|---|---|---|
| 572850 | November 1958 | BE | 433/64. |
| 1 193 122 | September 1985 | CA. | |
| 1124255 | October 1956 | FR | 433/54. |
| 446682 | June 1927 | DE | 433/58. |
| 596232 | December 1947 | GB | 433/62. |
| 2098070 | November 1982 | GB. | |

Dental articulators are too complicated and have too many parts. The dental professional needs something that will do the job simply and easily. As the complexity increases, the cost increases. More parts means more parts to break and more things to go wrong. A simple yet versatile one-piece disposable dental articulator that does the job will save time and money.

An excellent background description of disposable articulators is contained in U.S. Pat. No. 5,957,688. Although ingenious, the articulator described in U.S. Pat. No. 5,957,688 is still too complicated, and has many drawbacks including the time and skill required to articulate dental models. For example, channels have to be prepared and the articulator has to be glued is in place to these channels. Additionally, this articulator does not have vertical stops.

The present invention overcomes the disadvantages and provides benefits not foreseen in the prior art by combining simplicity and functionality in a convenient economical format. It allows quick and easy articulation of dental models so that the dental professional can focus on making the dental restoration.

### OBJECTS AND ADVANTAGES

It is an object of the present invention to provide a one-piece dental articulator.

It is an object of the present invention to provide a disposable dental articulator.

It is an object of the present invention to provide a one-piece disposable dental articulator.

It is an object of the present invention to provide a dental articulator that allows for lateral and protrusive translatory movement.

It is an object of the present invention to provide a one-piece dental articulator that allows quick and easy articulation of dental models.

It is an object of the present invention to provide a one-piece dental articulator that saves time.

It is an object of the present invention to provide a dental articulator that is economical.

It is an object of the present invention to provide a dental articulator that easy to use.

It is an object of the present invention to provide a dental articulator that is functional.

It is an object of the present invention to provide a dental articulator that is versatile.

It is an object of the present invention to provide a dental articulator that has many configurations.

It is an object of the present invention to provide a dental articulator that can be used for fixed prosthetics.

It is an object of the present invention to provide a dental articulator that can be used for removable prosthetics.

It is an object of the present invention to provide a dental articulator that has accurate and adjustable vertical stops.

### DESCRIPTION OF DRAWINGS

FIG. 1 is a perspective view of an embodiment having a body member with two hinged ends.

FIGS. 2a-2d are side views of various embodiments of the dental articulator.

FIG. 3 is a perspective view of an embodiment having an upper screw and a lower screw.

FIG. 4 is a perspective view of an embodiment having mounting plates.

FIG. 5 is a side view of an embodiment having short retention pins or long retention pins.

FIGS. 6a-6 are side views of various embodiments of the dental articulator with mounting plates.

FIG. 7 is a side view of an embodiment comprising an “L” shaped lower body member.

FIG. 8 is a side view of an embodiment comprising an “L” shaped lower body member comprising retention holes and an upper screw.

### REFERENCE: NUMERALS IN DRAWING

Reference: Numerals in Drawing

| | | | |
|---|---|---|---|
| 1 | dental articulator | 2 | body member |
| 3 | upper member | 4 | lower member |
| 5 | upper hinge | 6 | lower hinge |
| 7 | upper body retention holes | 8 | lower body retention holes |
| 9 | upper member retention holes | 10 | lower member retention holes |
| 11 | upper articulated model | 12 | lower articulated model |
| 13 | upper screw | 14 | lower screw |
| 15 | mounting plates | 16 | short retention pins |
| 17 | long retention pins | 18 | retention grid |
| 19 | “L” shaped lower body member | 20 | passive vertical stop |
| 21 | vertical lower body retention | 22 | horizontal lower body |
| | holes | | retention holes |

### DESCRIPTION OF PREFERRED EMBODIMENTS

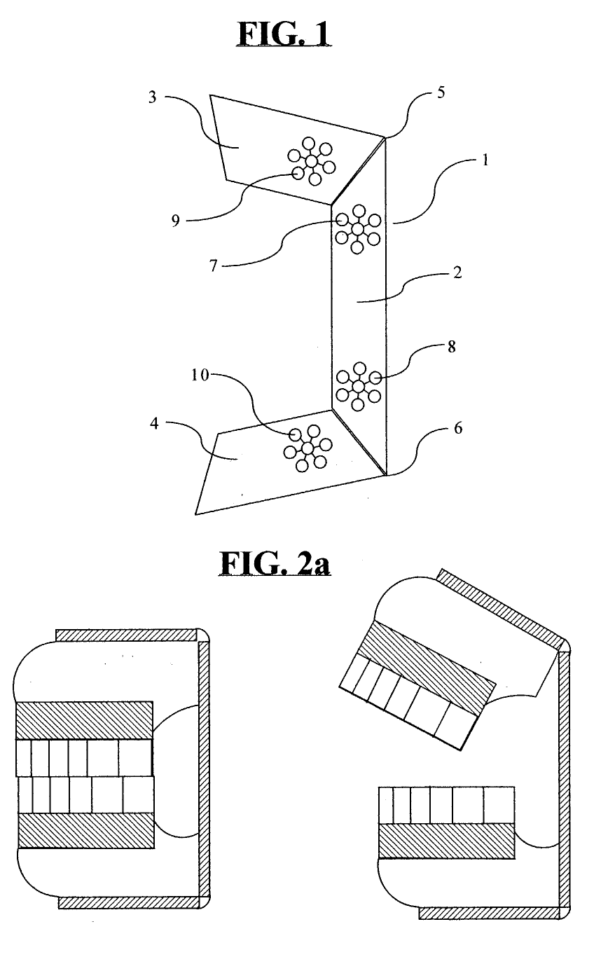

The present invention uses a dental articulator 1 in FIG. 1 constructed in one-piece from a single sheet of plastic that is scored perpendicular to the vertical length of the dental articulator at the upper and lower quadrants between a body member 2 and an upper member 3 to form an upper hinge 5, and between the body member and a lower member 4 to form a lower hinge 6. The hinges allow the upper and lower members free radial motion about the axis of the scored hinges and they are able to fold flush against the body member. On either side of the two hinges are upper body retention holes 7, lower body retention holes 8, upper member retention holes 9 and lower member retention holes 10 to hold articulated models.

The dental articulator is sufficiently resilient to allow for transverse motion along the vertical axis of the body member when sufficient force is applied in the direction of the desired motion. This allows for sufficient lateral and protrusive translatory motions and simulates occlusal and masticatory motions between the articulated models.

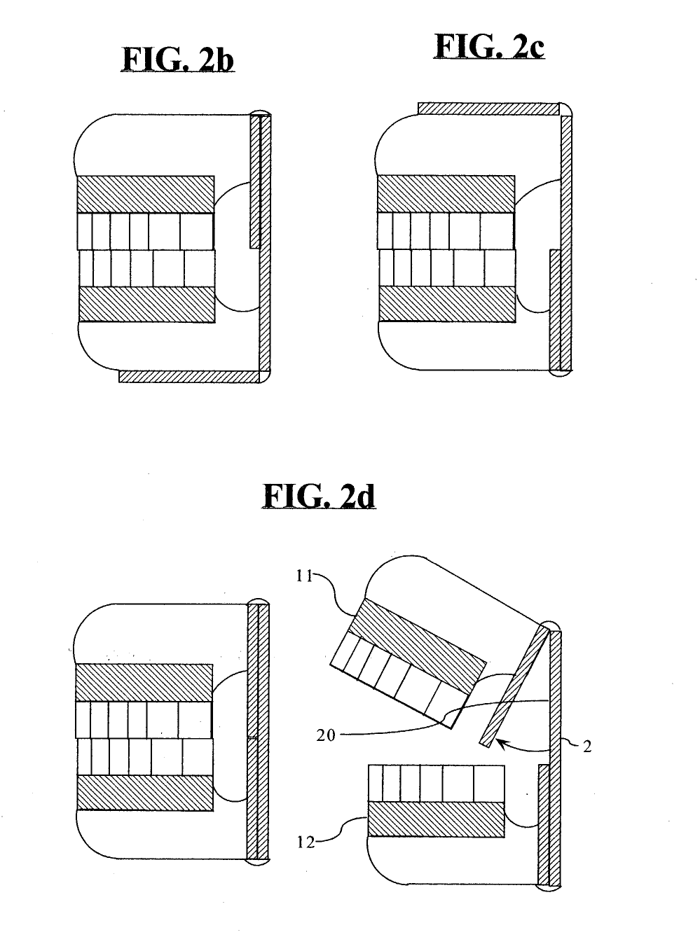

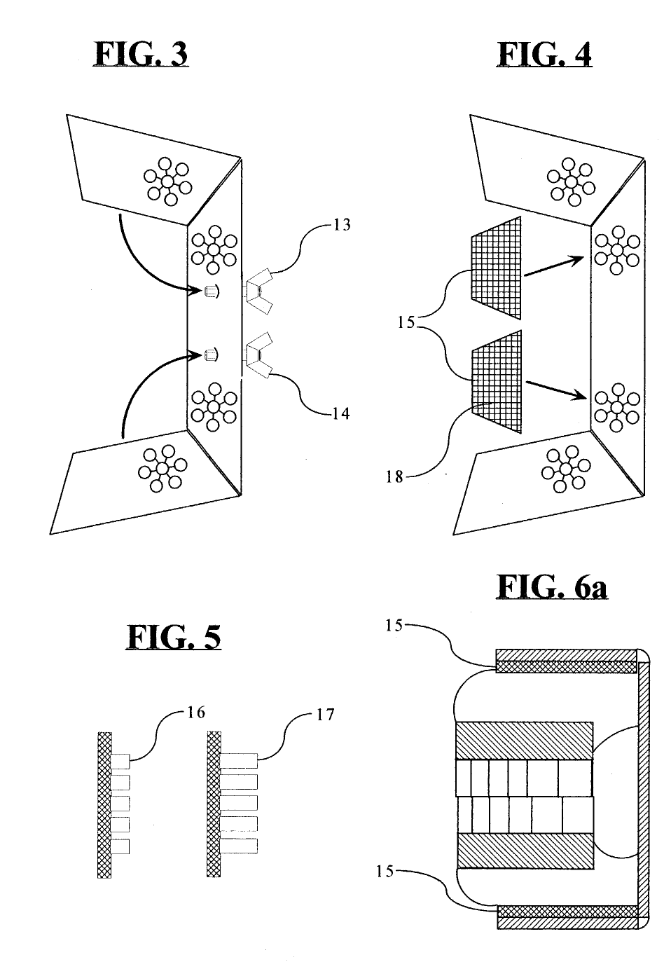

Accordingly, several alternative configurations of articulating models are possible as shown in FIGS. 2a-2d. In FIG. 2a, articulated models are sandwiched between the upper member and lower members. The retention holes secure the models in position. This configuration gives the dental professional a choice of using the upper hinge or lower hinge axis. The upper hinge is used by breaching the connection at the upper body retention holes to allow free movement of the upper hinge. Alternatively, the lower hinge can be used by breaching the connection at the lower body retention holes to allow free movement of the lower hinge.

Since the upper member and lower member are capable of folding flush against the body member, other configurations of articulating models are possible by folding either the upper member FIG. 2b, lower member FIG. 2c or both upper member and lower member FIG. 2d flush against the body member. In the flush position, two sets of retention holes secure the articulated models in position. The upper body retention holes and upper member retention holes are one set and the lower body retention and the lower member retention holes are the other set. Again, either hinge axis can be used.

The configurations in FIGS. 2a-2d, comprise a passive vertical stop 20 when the upper articulated model 11 or lower articulated model 12 comes to rest flush against the body member preventing further movement along the upper hinge or lower hinge axis in the direction of the body member.

In another embodiment, adjustable vertical stops use an upper screw 13 in FIG. 3 and a lower screw 14 to force the upper articulated model or lower articulated model away from the body member to the desired position.

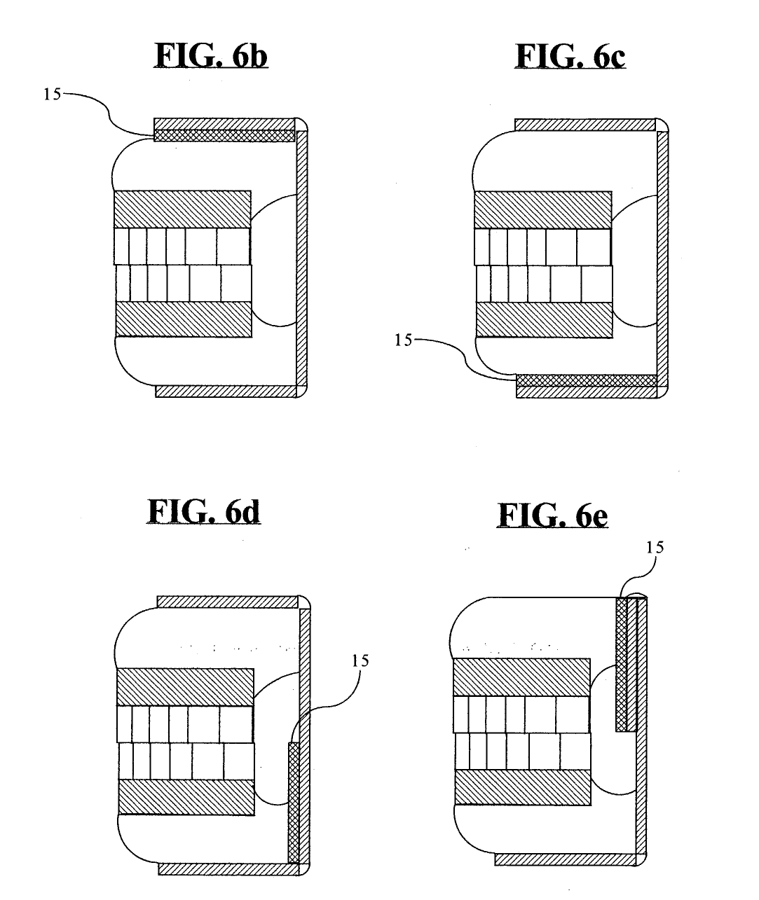

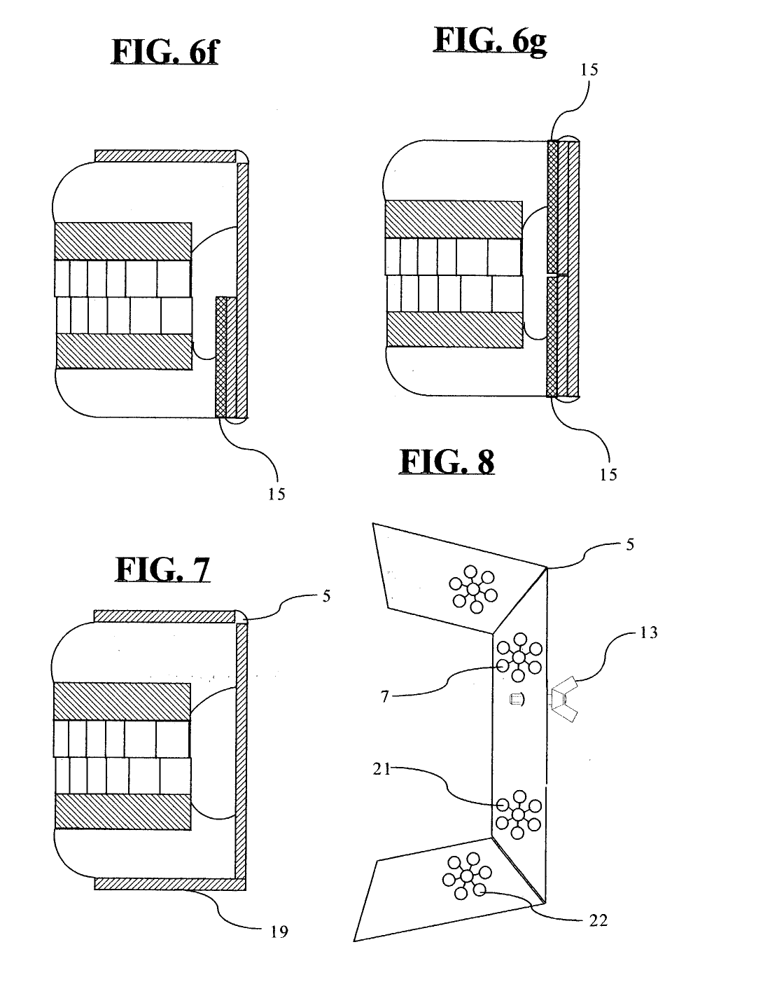

In a further embodiment, mounting plates 15 in FIG. 4 are provided comprising short retention pins 16 in FIG. 5 or long retention pins 11 on one side and a retention grid 18 in FIG. 4 on the other side. The retention grid secures the dental model to the mounting plate. The mounting plates are fixed on the dental articulator in various configurations by fitting the retention pins into the retention holes in the desired configuration. The long retention pins are used with the upper member or the lower member in the folded position to secure to the retention pins to the upper body retention holes or the lower body retention holes of the body member and maintain the folded position whereby the long retention pins pass through the upper member or the lower member. Some of the many configurations include fitting the retention pins to the various retention holes with the upper member or the lower member in the folded or unfolded position as illustrated in FIGS. 6a-6f.

Among the many configurations include articulated models sandwiched between said at least one mounting plate fixed on said upper member retention means and said lower member retention means, articulated models sandwiched between said upper member and said lower member with said at least one mounting plate fixed on said upper member retention means, articulated models sandwiched between said upper member and said lower member with said at least one mounting plate fixed on said lower member retention means, articulated models sandwiched between said upper member and said lower member with said at least one mounting plate fixed on said body member, an articulated model fixed to said at least one mounting plate on said tipper member folded flush against said body member, an articulated model fixed to said at least one mounting plate on said lower member folded flush against said body member and articulated models fixed to said at least one mounting plate on said upper member and said lower member folded flush against said body member.

A still further embodiment comprises an “L” shaped lower body member 19 in FIG. 7 and an upper hinge 5 whereby the only moving part is the upper hinge and the “L” shaped lower body member comprises a single solid piece. The dental articulator is scored perpendicular to its vertical length at the upper quadrant between said “L” shaped lower body member and said upper member to form said upper hinge thereby allowing free radial motion about the axis of said upper hinge. This embodiment further comprises upper body retention holes 7 in FIG. 8 for securing an upper articulated model, vertical lower body retention holes 21 for securing a lower articulated model, horizontal lower body retention holes 22 for securing a lower articulated model, upper member retention holes 9 for securing an upper articulated model. An upper screw 13 is provided.

Further, the dental articulator in this embodiment is sufficiently resilient to allow for transverse motion along the vertical axis of said “L” shaped lower body member when sufficient force is applied in the direction of the desired motion to allow for sufficient lateral and protrusive translatory motions and to simulate occlusal and masticatory motions.

Other embodiments include a dental articulator made of metal, plastic, composite, metal with scored hinges, plastic with scored hinges, composite with scored hinges, metal with conventional hinges, plastic with conventional hinges and composite with conventional hinges.

The dental articulator embodiments described herein are capable of being manufactured inexpensively by forming them from a single sheet of plastic without the use of costly molds or casts.

I claim:

1. A dental articulator comprising:
a. a body member;
b. an upper member;
c. an upper hinge;
d. a lower member and
e. a lower hinge.

2. A dental articulator according to claim 1 further comprising:
a. an upper body retention means for securing an upper articulated model;
b. a lower body retention means for securing a lower articulated model;
c. an upper member retention means for securing an upper articulated model; and
d. a lower member retention means for securing a lower articulated model.

3. A dental articulator according to claim 2 whereby said dental articulator is made in one-piece.

4. A dental articulator according to claim 2 whereby said dental articulator is scored perpendicular to the vertical length of the dental articulator at the upper and lower quadrants between said body member and said upper member to form said upper hinge and between said body member and said lower member to form said lower hinge thereby allowing free radial motion about the axis of said upper hinge and said lower hinge.

5. A dental articulator according to claim 2 whereby said dental articulator is sufficiently resilient to allow for transverse motion along the vertical axis of the body member when sufficient force is applied in the direction of the desired motion to allow for sufficient lateral and protrusive translatory motions and to simulate occlusal and masticatory motions.

6. A dental articulator according to claim 2 whereby a plurality of alternative configurations for articulating models are possible.

7. A dental articulator according to claim 6 selected form the group consisting of using said upper hinge by breaching the connection at the upper body retention holes to allow free movement of the upper hinge and using said lower hinge by breaching the connection at the lower body retention holes to allow free movement of the lower hinge.

8. A dental articulator according to claim 6 selected form the group consisting of
a. articulated models sandwiched between said upper member and said lower members;
b. said upper member is folded flush against said body member;
c. said lower member is folded flush against said body member;
d. said upper member and said lower member are folded flush against said body member.

9. A dental articulator according to claim 2 comprising a passive vertical stop whereby said upper articulated model or said lower articulated model comes to rest flush against the body member preventing further movement along the axis of said upper hinge or said lower hinge in the direction of the body member.

10. A dental articulator according to claim 2 whereby said dental articulator comprises an adjustable vertical stop selected from the group consisting of an upper screw and a lower screw.

11. A dental articulator according to claim 2 whereby said dental articulator comprises at least one mounting plate.

12. A dental articulator according to claim 11 whereby said at least one mounting plate is selected form the group consisting said at least one mounting plate with short retention pins and said at least one mounting plate with long retention pins.

13. A dental articulator according to claim 11 whereby said at least one mounting plate comprise a retention grid.

14. A dental articulator according to claim 11 whereby a plurality of alternative configurations for articulating models are possible using said at least one mounting plate.

15. A dental articulator according to claim 14 selected form the group consisting of
a. articulated models sandwiched between said at least one mounting plate fixed on said upper member retention means and said lower member retention means,
b. articulated models sandwiched between said upper member and said lower member with said at least one mounting plate fixed on said upper member retention means,
c. articulated models sandwiched between said upper member and said lower member with said at least one mounting plate fixed on said lower member retention means,
e. articulated models sandwiched between said upper member and said lower member with said at least one mounting plate fixed on said body member,
f. an articulated model fixed to said at least one mounting plate on said upper member folded flush against said body member,
g. an articulated model fixed to said at least one mounting plate on said lower member folded flush against said body member and
h. articulated models fixed to said at least one mounting plate on said upper member and said lower member folded flush against said body member.

16. A dental articulator according to claim 2 made of a material selected from the group consisting of metal, plastic, composite, metal with scored hinges, plastic with scored hinges, composite with scored hinges, metal with conventional hinges, plastic with conventional hinges and composite with conventional hinges.

17. A dental articulator comprising:
a. an “L” shaped lower body member;
b. an upper member;
c. an upper hinge

18. A dental articulator according to claim 17 comprising:
a. an upper body retention means for securing an upper articulated model;
b. a vertical lower body retention means for securing a lower articulated model;
c. a horizontal lower body retention means for securing a lower articulated model;
d. an upper member retention means for securing an upper articulated model; and
e. an upper screw.

19. A dental articulator according to claim 17 whereby said dental articulator is scored perpendicular to the vertical length of the dental articulator at the upper quadrant between said “L” shaped lower body member and said upper member to form said upper hinge thereby allowing free radial motion about the axis of said upper hinge.

20. A dental articulator according to claim 17 whereby said dental articulator is sufficiently resilient to allow for transverse motion along the vertical axis of said “L” shaped lower body member when sufficient force is applied in the direction of the desired motion to allow for sufficient lateral and protrusive translatory motions and to simulate occlusal and masticatory motions.
